(19) United States
(12) Patent Application Publication
(10) Pub. No.: US 2020/0314545 A1
(43) Pub. Date: Oct. 1, 2020

(54) DIAPHRAGM, METHOD FOR MANUFACTURING SAME, AND SPEAKER USING SAME

(71) Applicant: AAC Technologies Pte. Ltd., Singapore city (SG)

(72) Inventors: Ping Liang, Shenzhen (CN); Bin Zhao, Shenzhen (CN); Aixin Chen, Shenzhen (CN)

(21) Appl. No.: 16/729,500

(22) Filed: Dec. 30, 2019

(30) Foreign Application Priority Data
Mar. 26, 2019 (CN) 201910233975.1

(51) Int. Cl. H04R 7/06

(52) U.S. Cl. CPC H04R 7/06; H04R 1/02

(57) ABSTRACT

The present invention provides a diaphragm including a first polymer substrate material made of polymer material, a second polymer substrate material made of polymer material, and a porous damping substrate material made of porous damping material. The porous damping substrate material has a first side surface and a second side surface opposite to the first side surface. The first polymer substrate material is fixed to the first side surface, and the second polymer substrate material is fixed to the second side surface. The first polymer substrate material and/or the second polymer substrate material are at least partially embedded in the porous damping substrate material. The diaphragm in the invention can reduce the amplitude deviation under high temperature. Further, the invention provides a method for forming the diaphragm and a speaker using the same.

### FIELD OF THE PRESENT DISCLOSURE

The present invention relates to the field of electroacoustic devices, particularly to a diaphragm, and to a method for manufacturing the diaphragm. The present invention further relates to a speaker using the diaphragm.

### DESCRIPTION OF RELATED ART

At present, materials of diaphragm are generally single-layer or composite materials such as silicone rubber, thermoplastic elastomer (TPE), thermoplastic polyurethane elastomer rubber (TPU), etc. These polymer materials have good elasticity with a small modulus, and are often used in the preparation of existing diaphragms. However, because these polymer materials are not resistant to high temperatures. When the temperature rises to a certain level (the product continues to vibrate or perform reliability experiments), in some products, the product amplitude becomes larger and larger, which causes deviations, results in product swing, then directly leads to product performance failure. FIG. 1 is the amplitude change diagram of respective vibration of 20 ms (millisecond) and 500 ms with material of diaphragm at different temperatures, 20 ms and 500 ms represent different time used to test the existing material of diaphragm in the same frequency phase interval, the longer the time, the more vibrations and the higher the product temperature. From the figure we can see the significant deviation of the vibration amplitude of same pint on the product using the existing diaphragm under the test conditions of 20 ms and 50 ms.

Accordingly, an improved diaphragm, and a speaker using the diaphragm are desired to solve the problems mentioned above.

### SUMMARY OF THE PRESENT INVENTION

One of the major objects of the present invention is to provide a diaphragm used in a speaker which can reduce the amplitude deviation under high temperature.

Another of the major objects of the present invention is to provide a method for manufacturing the diaphragm to reduce the amplitude deviation under high temperature.

A further one of the major objects of the present invention is to provide a speaker having the diaphragm.

In order to achieve the objects mentioned above, the present invention provides a diaphragm, including a diaphragm substrate material having a first polymer substrate material made of polymer material, a second polymer substrate material made of polymer material, and a porous damping substrate material made of porous damping material, wherein the porous damping substrate material comprises a first side surface and a second side surface opposite to the first side surface; the first polymer substrate material is fixed to the first side surface; the second polymer substrate material is fixed to the second side surface; and the first polymer substrate material and/or the second polymer substrate material are at least partially embedded in the porous damping substrate material.

Further, the material of the first polymer substrate material is different from the material of the second polymer substrate material.

Further, the first polymer substrate material and the second polymer substrate material are at least partially embedded in the porous damping substrate material.

Further, the porous damping substrate material comprises a plurality of through holes arranged through from the first side surface to the second side surface, the first polymer substrate material comprises a first polymer material layer stacked on the first side surface and a first polymer material embedded layer embedded in the through hole, the second polymer substrate material comprises a second polymer material layer stacked on the second side surface and a second polymer material embedded layer embedded in the through hole.

Further, the polymer material substrate is made of at least one of silicone rubber, thermoplastic elastomer, thermoplastic polyurethane elastomer rubber, polyetheretherketone, and polyethylene terephthalate.

Further, the porous damping substrate material is made of at least one of polyphthalamide and polyetherketone material.

The present invention further provides a method for manufacturing a diaphragm as described above, comprising steps of: providing a first polymer substrate plate, a second polymer substrate plate, and a porous damping substrate plate, respectively; and fixing the first polymer substrate plate and the second polymer substrate plate respectively to the first side surface and the second side surface of the porous damping substrate plate by high temperature molding.

Further, a sum of the thickness of the first polymer substrate plate and the thickness of the second polymer substrate plate is greater than a thickness of the porous damping substrate plate.

The present invention further provides a speaker comprising a magnetic circuit system, a vibration system, a frame provided with an accommodation cavity for receiving the magnetic circuit system and the vibration system; wherein the vibration system comprises a diaphragm as described above connected to a top of the frame.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is a vibration amplitude change schematic diagram of existing diaphragm when vibrating respectively 20 ms and 500 ms at different temperatures;

FIG. 2 is isometric view of a diaphragm substrate material provided in embodiment 1 of the present invention;

FIG. 3 is a front view of the diaphragm substrate material provided in the embodiments of the present invention;

FIG. 4 is a cross-sectional view of the diaphragm substrate material provided in the embodiment 1 of the present invention;

FIG. 5 is a vibration amplitude change schematic diagram of the diaphragm substrate material provided in embodiment 1 of the present invention when vibrating respectively 20 ms (millisecond) and 500 ms at different temperatures;

FIG. 6 is an exploded view of a polymer substrate plate and a porous damping substrate plate provided in the embodiment 1 of the present invention after being stacked and before high temperature molding;

FIG. 7 is an isometric view of a speaker using the diaphragm substrate material;

FIG. 8 is a cross-sectional view of the speaker taken along line A-A in FIG. 6.

FIG. 9 is a cross-sectional view of the diaphragm substrate material provided in an embodiment 2 of the present invention.

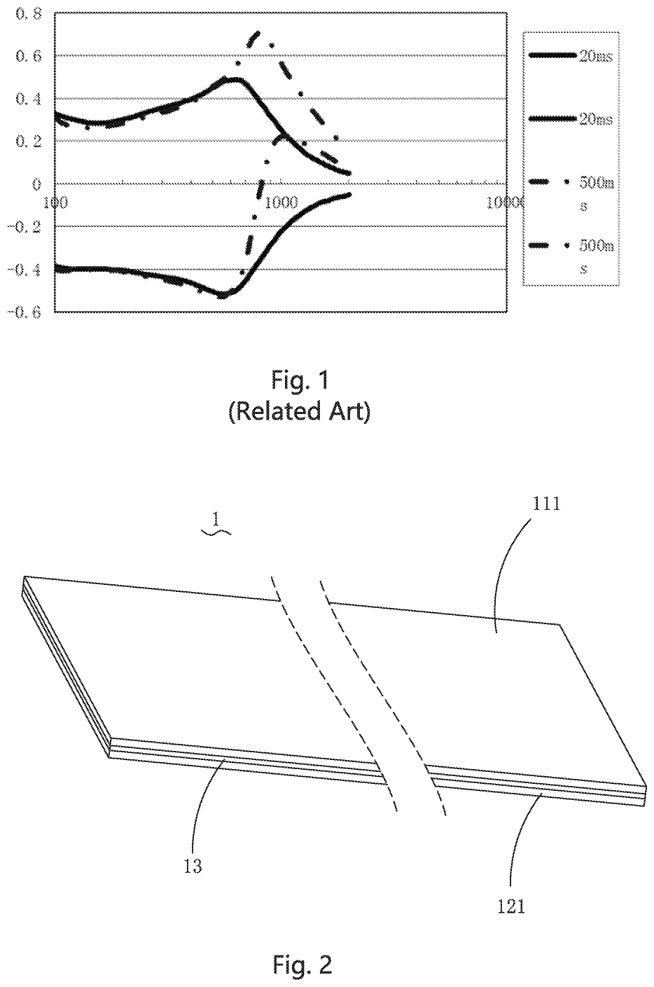

### DETAILED DESCRIPTION OF THE EXEMPLARY EMBODIMENTS

The present disclosure will hereinafter be described in detail with reference to several exemplary embodiments. To make the technical problems to be solved, technical solutions and beneficial effects of the present disclosure more apparent, the present disclosure is described in further detail together with the figure and the embodiments. It should be understood the specific embodiments described hereby are only to explain the disclosure, not intended to limit the disclosure.

### Embodiment 1

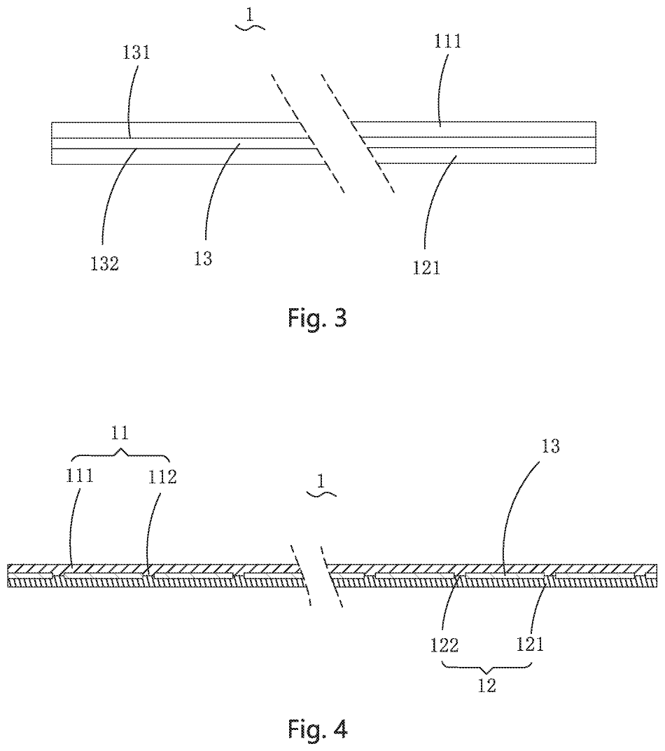

As shown in FIGS. 2-5, a diaphragm substrate material 1 provided in embodiments of the present invention comprises a first polymer substrate material 11 made of polymer material, second polymer substrate material 12 made of polymer material, and a porous damping substrate material 13 made of porous damping material. The porous damping substrate material 13 comprises a first side surface 131 and a second side surface 132 arranged with backside opposite to each other. The first polymer substrate material 11 is fixed to first side surface 131, the second polymer substrate material 12 is fixed to second side surface 132, the first polymer substrate material 11 and/or the second polymer substrate material 12 are at least partially embedded in the porous damping substrate material 13. Because the porous damping substrate material 13 is added to the diaphragm substrate material 1 in this embodiment, the porous damping material has high structural strength and can restrain the contractility of the polymer material, so that the dimensions of products made of the diaphragm substrate material 1 of this embodiment can be kept consistent. In addition, the diaphragm substrate material 1 of this embodiment can restrain and improve the performance variation of polymer materials under high temperature conditions, therefore, the amplitudes of products such as speaker made of the diaphragm substrate material 1 of this embodiment have a smaller vibration deviation with increasing temperature, which improves product performance stability.

In this embodiment, the porous damping substrate material 13 comprises a plurality of through holes 133 which are arranged through from the first side surface 131 to the second side surface 132. The first polymer substrate material 11 comprises a first polymer material layer 111 stacked on a first side surface 131 and a first polymer material embedded layer 112 embedded in the through hole 133. The first polymer material layer 111 and the first polymer material embedded layer 112 are integrally formed. The second polymer substrate material 12 comprises a second polymer material layer 121 stacked on a second side surface 132 and a second polymer material embedded layer 122 embedded in the through hole 133. The second polymer material layer 121 and the second polymer material embedded layer 122 are integrally formed.

Preferably, the materials of the first polymer substrate material 11 and the second polymer substrate material 12 are different. In this embodiment, the materials of the first polymer substrate material 11 and the second polymer substrate material 12 are two different polymer materials.

Preferably, the polymer material substrate is made of at least one of silicone rubber, thermoplastic elastomer (TPE), thermoplastic polyurethane elastomer rubber (TPU), polyetheretherketone (PEEK), and polyethylene terephthalate (PET). These polymer materials have small elastic modulus and relatively good elasticity.

Preferably, the porous damping substrate materials made of at least one of polyphthalamide and polyetherketone materials. These porous damping material have high structural strength and can restrain the variation of polymer material properties under high temperature conditions.

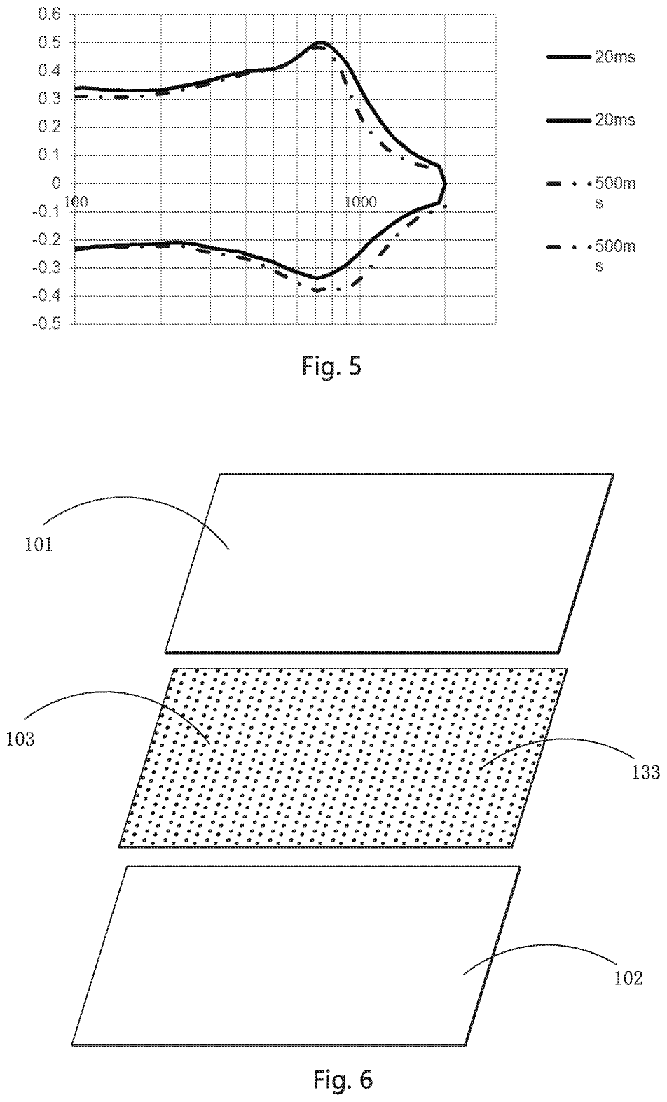

FIG. 5 is the amplitude change diagram of respective vibration of 20 ms and 500 ms with diaphragm substrate material 1 provided in this embodiment at different temperatures, 20 ms and 500 ms represent different time used to test the diaphragm substrate material 1 of this embodiment in the same frequency phase interval. We can see that the diaphragm substrate material 1 of this embodiment has a small amplitude deviation at the same point on the product under the test conditions of 20 ms and 50 ms.

This embodiment also provides a method for manufacturing the above-mentioned diaphragm substrate material 1, including the following steps:

Prepare first polymer substrate plate 101, second polymer substrate plate 102, and porous damping substrate plate 103 respectively;

Fix the first polymer substrate plate 101 and the second polymer substrate plate 102 respectively to the first side surface 131 and the second side surface 132 of the porous damping substrate plate 103 by high temperature molding to form a diaphragm substrate material 1.

In the present invention, the diaphragm substrate material will be a diaphragm when used in a speaker for generating and radiating sounds. Thus, we can understand that the diaphragm substrate material will serve as a diaphragm when used in a speaker. The method described above is also the method for manufacturing the diaphragm.

Preferably, the sum of the thickness of the first polymer substrate plate 101 and the thickness of the second polymer substrate plate 102 is greater than the thickness of the porous damping substrate plate 103. In this embodiment, the thickness of the first polymer substrate plate 101 is greater than the thickness of the porous damping substrate plate 103. Of course, in specific applications, the thickness of the first polymer substrate plate 101 may also be designed to be less than or equal to the thickness of the porous damping substrate plate 103. At the same time, the thickness of the second polymer substrate plate 102 is also greater than the thickness of the porous damping substrate plate 103. Of course, in specific applications, the thickness of the second polymer substrate plate 102 may also be designed to be less than or equal to the thickness of the porous damping substrate plate 103.

As shown in FIG. 6, when preparing the diaphragm substrate material 1, first, the first polymer substrate plate 101 is stacked on the first side surface 131 of the porous damping substrate plate 103, the second polymer substrate plate 102 is stacked on the second side surface 132 of the porous damping substrate plate 103, and then high temperature molding is applied. The polymer material of which the first polymer substrate plate 101 is made, is embedded from the first side surface 131 into the through hole 133 of the porous damping substrate plate 103 to form a first polymer material embedded layer 112. The polymer material still stacked on the first side surface 131 of porous damping substrate plate 103 forms first polymer material layer 111, the polymer material, of which the second polymer substrate plate 102 is made, is embedded from the second side surface 132 into the through hole 133 of the porous damping substrate plate 103 to form a second polymer material embedded layer 122. The polymer material still stacked on the second side surface 132 of the porous damping substrate plate 103 forms a second polymer material layer 121, and porous damping substrate plate 103 forms porous damping substrate material 13.

In the present embodiment, the first side surface 131 of the porous damping substrate material 13 and the first side surface 131 of the porous damping substrate plate 103 are the same side surface. The second side surface 132 of the porous damping substrate material 13 and the second side surface 132 of porous damping substrate plate 103 are the same side surface. The through hole 133 of the porous damping substrate material 13 is the same as the through hole 133 of the porous damping substrate plate 103.

The diaphragm provided in this embodiment is processed from the aforementioned diaphragm substrate material 1. Because the above-mentioned diaphragm substrate material 1 is used for processing, the deviation of the vibration amplitude of the diaphragm is small when temperature increases, so the product performance is relatively stable. Processing the diaphragm substrate material 1 to form a diaphragm specifically include processing operations such as cutting, stamping and forming the diaphragm substrate material 1.

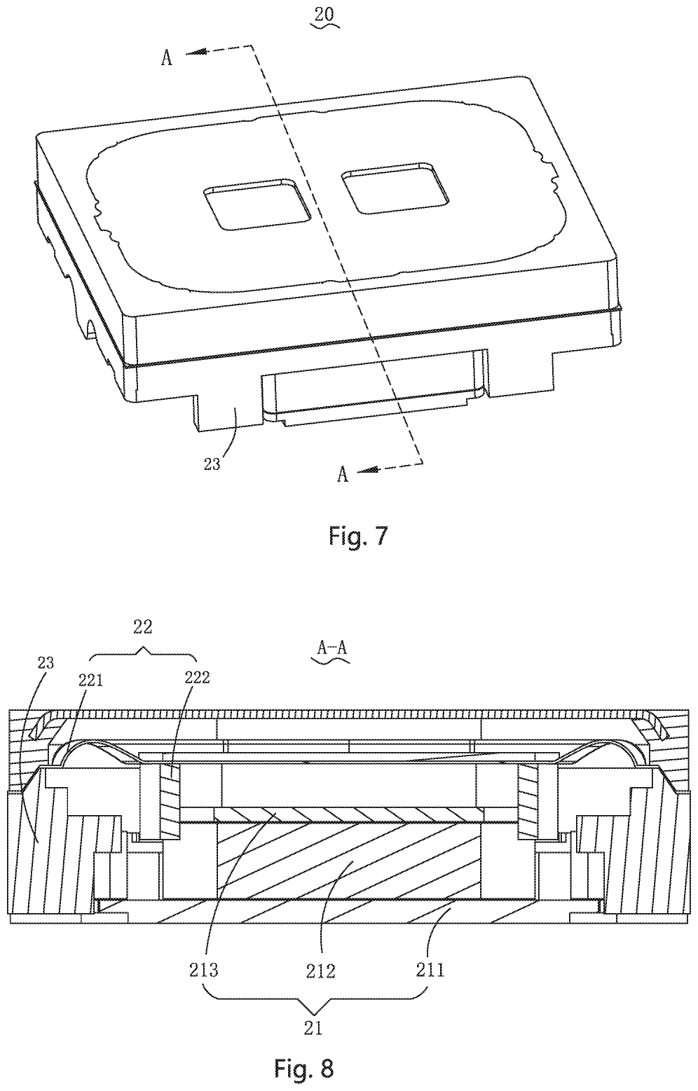

Shown in FIGS. 7-8, a speaker 20 provided in the present embodiment comprises a magnetic circuit system 21, a vibration system 22, a frame provided with an accommodation cavity. Both magnetic circuit system 21 and vibration system 22 are accommodated in the accommodation cavity. The vibration system 22 comprises a diaphragm 221 connected to the top of the frame 23. The diaphragm 221 is made of the diaphragm substrate material by the method mentioned above. The first polymer material layer 111 or the second polymer material layer 121 is arranged on the side of the diaphragm 221 near the frame 23. In a preferred embodiment, the magnetic circuit system 21 comprises a magnetic frame 211 connected to the bottom of the frame 23, a permanent magnet 212 accommodated in the magnetic frame 211, and a pole plate 213 fixed on the top of the permanent magnet 212.

The bottom of the permanent magnet 212 is fixed in the magnetic frame 211, vibration system 22 comprises a diaphragm 221 connected to the top of the frame 23 and a voice coil 222 arranged at the bottom of diaphragm 221 and positioned in the accommodation cavity. The voice coil 222 moves under the influence of the magnetic field generated by the magnetic circuit system 21, thereby driving the diaphragm 221 to vibrate up and down.

### Embodiment 2

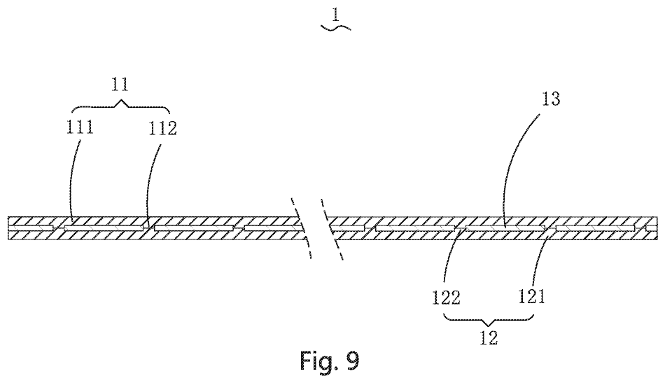

As shown in FIG. 9, the difference between the embodiment 1 and the embodiment 2 is mainly that in the embodiment 1, the materials of the first polymer substrate plate 101 and the second polymer substrate plate 102 are different. In this embodiment, the materials of the first polymer substrate plate 101 and the second polymer substrate plate 102 are the same.

The first polymer substrate plate 101 and the second polymer substrate plate 102 are stacked on the first side surface 131 and the second side surface 132 of the porous damping substrate plate 103, respectively. Then high temperature molding is applied to form a first polymer material layer 111 and a second polymer material layer 121 are a polymer material embedded layer. The polymer material embedded layer comprises a first polymer material embedded layer 112 embedded into a porous damping substrate plate 103 by using first polymer substrate plate 101 through high temperature molding, a second polymer material embedded layer 122 embedded into the porous damping substrate plate 103 by using the second polymer substrate plate 102 through high temperature molding. The first polymer material layer 111 and the first polymer material embedded layer 112 are integrally formed, and the second polymer material layer 121 and the second polymer material embedded layer 122 are integrally formed.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A diaphragm comprising a diaphragm substrate material having a first polymer substrate material made of polymer material, a second polymer substrate material made of polymer material, and a porous damping substrate material made of porous damping material, wherein
the porous damping substrate material comprises a first side surface and a second side surface opposite to the first side surface;
the first polymer substrate material is fixed to the first side surface;
the second polymer substrate material is fixed to the second side surface; and
the first polymer substrate material and/or the second polymer substrate material are at least partially embedded in the porous damping substrate material.

2. The diaphragm as described in claim 1, wherein the material of the first polymer substrate material is different from the material of the second polymer substrate material.

3. The diaphragm as described in claim 1, wherein the first polymer substrate material and the second polymer substrate material are at least partially embedded in the porous damping substrate material.

4. The diaphragm as described in claim 1, wherein the porous damping substrate material comprises a plurality of through holes arranged through from the first side surface to the second side surface, the first polymer substrate material comprises a first polymer material layer stacked on the first side surface and a first polymer material embedded layer embedded in the through hole, the second polymer substrate material comprises a second polymer material layer stacked on the second side surface and a second polymer material embedded layer embedded in the through hole.

5. The diaphragm as described in claim 1, wherein the polymer material substrate is made of at least one of silicone rubber, thermoplastic elastomer, thermoplastic polyurethane elastomer rubber, polyetheretherketone, and polyethylene terephthalate.

6. The diaphragm as described in claim 2, wherein the polymer material substrate is made of at least one of silicone rubber, thermoplastic elastomer, thermoplastic polyurethane elastomer rubber, polyetheretherketone, and polyethylene terephthalate.

7. The diaphragm as described in claim 3, wherein the polymer material substrate is made of at least one of silicone rubber, thermoplastic elastomer, thermoplastic polyurethane elastomer rubber, polyetheretherketone, and polyethylene terephthalate.

8. The diaphragm as described in claim 4, wherein the polymer material substrate is made of at least one of silicone rubber, thermoplastic elastomer, thermoplastic polyurethane elastomer rubber, polyetheretherketone, and polyethylene terephthalate.

9. The diaphragm as described in claim 5, wherein the porous damping substrate material is made of at least one of polyphthalamide and polyetherketone material.

10. The diaphragm as described in claim 6, wherein the porous damping substrate material is made of at least one of polyphthalamide and polyetherketone material.

11. The diaphragm as described in claim 7, wherein the porous damping substrate material is made of at least one of polyphthalamide and polyetherketone material.

12. The diaphragm as described in claim 8, wherein the porous damping substrate material is made of at least one of polyphthalamide and polyetherketone material.

13. A method for manufacturing a diaphragm as described in claim 1, comprising steps of:
providing a first polymer substrate plate, a second polymer substrate plate, and a porous damping substrate plate, respectively;
fixing the first polymer substrate plate and the second polymer substrate plate respectively to the first side surface and the second side surface of the porous damping substrate plate by high temperature molding.

14. The method as described in claim 13, wherein a sum of the thickness of the first polymer substrate plate and the thickness of the second polymer substrate plate is greater than a thickness of the porous damping substrate plate.

15. A speaker comprising:
a magnetic circuit system;
a vibration system;
a frame provided with an accommodation cavity for receiving the magnetic circuit system and the vibration system; wherein
the vibration system comprises a diaphragm as described in claim 1 connected to a top of the frame.
